(19) United States
(12) Patent Application Publication
(10) Pub. No.: US 2002/0063725 A1
(43) Pub. Date: May 30, 2002

(54) Method and apparatus for capturing and presenting panoramic images for websites

(75) Inventors: William L. Tarbutton, Preston, MD (US); Eva J. Dupont, Seaford, DE (US); Lisa I. Tarbutton, Preston, MD (US)

Correspondence Address: Lawrence E. Laubscher, Sr., 745 South 23rd Street, Arlington, VA, 22202-2451, US

(73) Assignee: VirtuallyListed LLC

(21) Appl. No.: 09/726,116

(22) Filed: Nov. 30, 2000

(51) Int. Cl. G09G 5/00

(52) U.S. Cl. 345/629

(57) ABSTRACT

A method and apparatus for displaying on the monitor screen of a user webpage displaying a plurality of cropped portions of a plurality of panoramic images, respectively, and for displaying in a spinning mode the panoramic image that corresponds with a selected one of the cropped image portions. A corresponding audio presentation may accompany the spinning panoramic display. The cropped or panoramic images are displayed on a webpage that is provided either by the image provider or by a Website provider.

### FIELD OF THE INVENTION

A method and apparatus are disclosed for capturing and presenting panoramic images on a user's Website, characterized in that a selected panoramic image produced by a leveled rotating camera is displayed in a spinning mode.

### BACKGROUND OF THE INVENTION

Brief Description of the Prior Art

If is known in the prior art to produce panoramic images by means of a camera that rotates on a stationary tripod, as shown for example, by the Oxaal U.S. Pat. No. 5,903,782, Whiting, et al., U.S. Pat. No. 6,034,716, James U.S. Pat. No. 1,503,437, Borden U.S. Pat. No. 5,752,113, Bigsby-Chamberling U.S. Pat. No. 651,521, Mittelstaedt, et al., U.S. Pat. No. 5,870,642, and Campbell, et al., U.S. Pat. No. 3,183,810, among others. The camera rotating device can be leveled as shown by the patents to Wainwright U.S. Pat. Nos. 5,040,759 and 5,259,584, among others.

The resultant panoramic image produced by the tripod-mounted rotating cameras can be spliced or stitched together to form a substantively continuous panoramic view, as shown by the patents to Teo U.S. Pat. No. 6,128,108, Jackson U.S. Pat. No. 5,990,941, and Roy, et al., U.S. Pat. No. 6,023,588, among others.

It is also known in the art to provide panoramic and/or other images on a user's image display, video display, Website or the like, as shown by the patents to Melby, et al., U.S. Pat. No. 5,850,579, Driscoll, et al., U.S. Pat. No. 6,043,837, Martin, et al., U.S. Pat. No. 5,764,276, and Sotiroff, et al., U.S. Pat. No. 5,852,810, among others.

The above image display techniques have been used extensively in the sales marketing field, particularly in the field of real estate and personal property, as shown, for example, by the patents to Janssen U.S. Pat. No. 5,754,850, Fraser U.S. Pat. No. 5,664,115, Tometta U.S. Pat. No. 5,032,989, Nahan, et al., U.S. Pat. No. 5,999,915, and Hess, et al., U.S. Pat. No. 6,058,417.

Traditional real estate webpages work in several ways. One, they compile information from multiple listing services databases and display the search results on their Website as their own. The disadvantage to this is that one has to be a member of the listing service to have access to the database and one's home has to be listed by a multiple listing service agent to be part of the database. This eliminates anyone that is not a licensed realtor from being able to access the information or a homeowner trying to sell his or her own home without a listing agent.

These types of sites usually require extensive search parameters to narrow down these large databases to a concentrated region. Usually, they require the user to input a state, city, or county, minimum requirements in the home—type of home, number of bedrooms, bathrooms, etc., a minimum and maximum price range, acreage, etc. It can be very cumbersome because all the parameters for each search have to be reentered.

The second type of real estate site is a regional database. This type of a site allows multiple property managers (agents) to input their own information into the system via a username and password and the information is placed into a pre-established format. The accuracy and freshness of the information is dependent on the diligence of the individual property managers.

The disadvantage of this is type of site is that you are relying on the realtors/agents to maintain it. Also, there is no room to accommodate individual needs—users are limited to the Website's “model” information.

Thirdly and most importantly, traditional sites have only included still photos of a home or property. In recent years, “virtual tours” have become available to the masses. These “tours” are typically 360° panoramic images that are spun using a separate viewer. the tours are generally compiled either through a flat panoramic “stitching” program using many individual shots, a 185° fisheye lens which involves two warped shots “stitched” together, or an actual 360° degree photograph which requires no stitching, but has significant warp because it is photographed off of a curved mirror.

After looking at many of the “tours” on the market and how they are displayed, we were quite dissatisfied. Almost every “Virtual Tour” company on the market requires you to purchase something from them. For example, one must purchase “key” allowing you to post the image to the web, 360 Degree uses special film to allow a seamless panoramic to be captured in a single shot.

While the above image presenting systems have merit, it has proven to be desirable from a marketing standpoint—particularly in the real estate marketing field—to display a panoramic image that will slowly spin or rotate through an angle of 360°, whereby the viewer, such as a prospective customer, will be provided with a complete view of, for example, the interior of one or more rooms of a dwelling. This presentation may be made with or without sound.

The present invention was developed to provide an improved marketing system for displaying images on a Website or the like to promote the sale of real and personal property, such as real estate, boats, automobiles, art work or the like.

### SUMMARY OF THE INVENTION

Accordingly, a primary object of the present invention is to provide an improved method and apparatus for displaying panoramic images on a Website, characterized one of a plurality of images on the Website may be caused to spin or rotate, thereby to afford a 360° viewing of the object being displayed.

According to another object of the invention, the spinning image may be accompanied by an audio presentation corresponding with the image being rotated.

According to a more specific object of the invention, the panoramic image to be displayed on the Website is obtained by the use of a digital camera that is rotatably supported by a leveled tripod platform, stitching means being provided for splicing together the images produced by the rotating camera. The resultant spliced panoramic image is cropped at desired locations, and a plurality of cropped images taken from a plurality of panoramic views, respectively, are displayed on the user's screen. Actuation of a selected one of the cropped imaged causes the corresponding panoramic image to be spun or rotated at a given location on the user's webpage.

According to a further object of the invention, an exclusive entry image displaying system is provided in which the aforementioned panoramic and cropped images are stored on an image provider web server, and the web page is provided by a Website provider, such as a real estate company. In one embodiment, the image on the prospective customer's screen includes a webpage obtained from the webpage provider web server, and cropped and panoramic images provided from the image provider web server. According to a second embodiment, the images produced on the prospective customer's screen include an initial Website obtained from the Website provider web server, and a subsequent Website that is compatible with the initial Website and that is provided from the image provider's web server, together with the selected cropped and panoramic images.

According to a another object of the invention, an improved tripod-mounted digital camera system is provided for generating the photographs from which the panoramic image is obtained.

### BRIEF DESCRIPTION OF THE DRAWINGS

Other objects and advantages of the invention will become apparent from a study of the following specification when viewed in the light of the accompanying drawings, in which:

FIG. 1 is a block diagram illustrating the three major steps of the invention comprising capturing the images, creating panoramic and thumbnail images, and presenting the panoramic image on an Internet web page;

FIG. 2 is a block diagram illustrating the steps of capturing the necessary images;

FIG. 3 is a block diagram illustrating the steps of creating the panoramic image and thumbnail images;

FIG. 4 is a block diagram illustrating the steps of presenting the panoramic and thumbnail images and sound files on an Internet webpage;

FIG. 5 is a block diagram illustrating the steps of displaying a webpage which may include text, cropped images, panoramic images, and sound files from an image provider web server upon the actuation on a webpage supplied from a Website provider web server;

FIG. 6 is a block diagram illustrating the steps of presenting panoramic and cropped images, and sound files, from the an Image Provider web server within a webpage supplied from the Website provider web server;

FIG. 7 is a top plan view of the camera mounting plate; and

FIG. 8 is a detailed side elevation view of the digital camera, level, mounting plate and tripod assembly.

### DETAILED DESCRIPTION

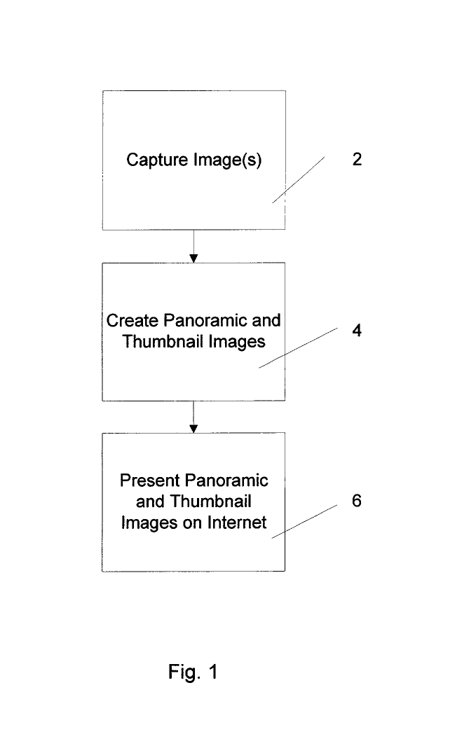

Referring to FIG. 1, the capture images feature 2 involves the steps of capturing the various images which are later utilized throughout the system. The create panoramic and thumbnail images section 4 ‘stitches’ the various images into one 360° panoramic image. Further, various ‘thumbnail’ or smaller, single images are created. The presentation of the panoramic and thumbnail images on the Internet 6 publishes the images on a webpage to allow for the navigation and utilization on the images in an Internet application.

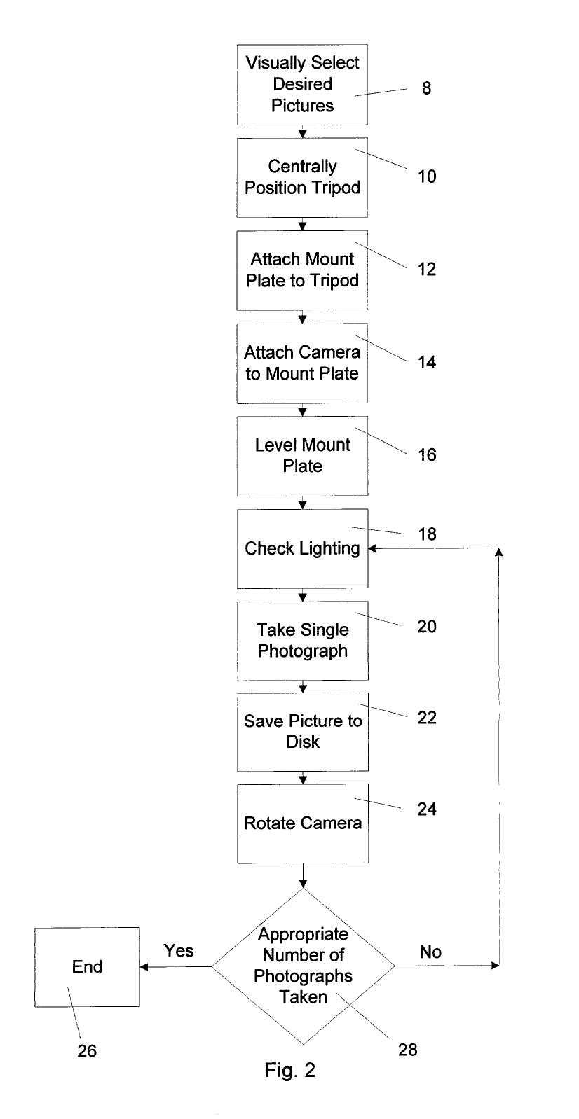

FIG. 2 illustrates the steps of capturing of multiple images. Initially, the subject for the images is determined, and the photographer visually selects the desired pictures 8. In the best mode of the invention, the desired pictures include real estate items such as the exterior of a property, the interior rooms of the property, or the surrounding area. Upon determining the desired pictures 8, the tripod is centrally mounted 10 within the desired setting where the images will be taken. Next, the mount plate is attached 12 to the now centrally positioned tripod. The camera which will take the photographs is then attached to the mount plate 14. This occurs by utilizing the mating threaded screw of the mount plate and the receiving port within the base of the camera. After the camera is mounted onto the plate 14, the plate is leveled 16 by placing a level at an distance from the central pivot point that is equal to the distance the camera mounted from the central pivot point. The leveling procedure allows the camera to be leveled on both the horizontal X and the Y axes. The lighting is then checked 18 prior to the photograph being taken. After the appropriate lighting readings have occurred, a single photograph is taken 20. The photograph is then saved to disk 22. Following this successful capturing of one image, the camera is rotated 24 along the horizontal axis and appropriately positioned such that the next, subsequent photograph may be taken. A determination is made as to whether a sufficient number of photographs have been captured 28 to allow for a seamless compilation into one, 360° panoramic image. If it is determined that the appropriate number of photographs have been taken 28, the image capturing process ends 26 However, if it is determined that an appropriate number of photographs have not been taken 28, processing is returned to checking the lighting 18 in preparation to take another photograph.

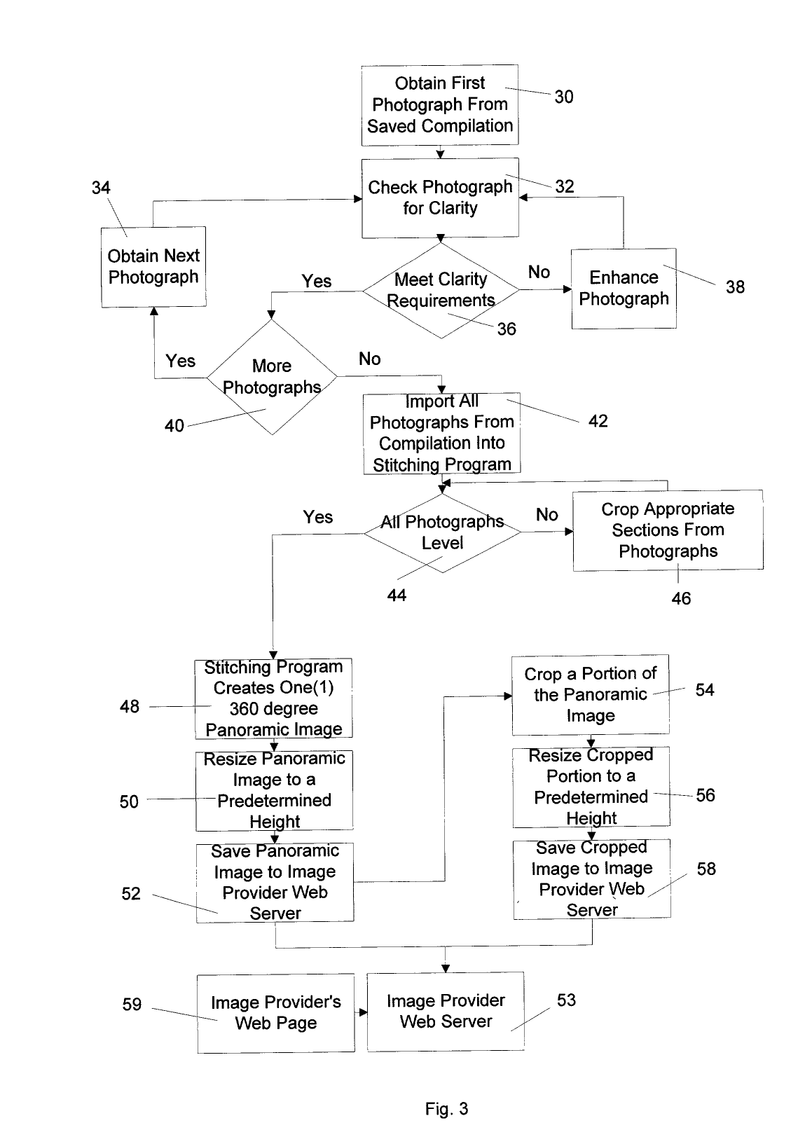

FIG. 3 illustrates the steps of creating the panoramic and thumbnail images. Initially, the first image is obtained from the overall compilation of all of the saved images 30. The photograph is then checked for clarity 32 to ensure that it will be acceptable for the upcoming stitching process. A determination 36 is conducted to determine if the photograph meets the clarity requirements. If the clarity requirements are not met, the photograph is enhanced 38 and then checked again for clarity 32. If the image does meet the clarity requirements 36, a test is conducted 40 to determine if there are more photographs to process. If there are more photographs to process within the saved compilation of photographs, the next photograph from the compilation is obtained 34 and that selected photograph is then checked for clarity 32. If there are no further photographs which have not both been checked for clarity 32 and met the clarity requirements 36, then all of the photographs from the compilation are imported into the stitching program 42. Next, a determination is made as to whether all of the photographs imported into the stitching program are level 44. If the photographs are not level, appropriate sections from the photograph are cropped 46, and the photograph is retested to determine if all the photographs are level 16. If the photographs are level, the stitching program creates one 360° panoramic image 48. The panoramic image is then resized to a predetermined height 50 which provides an optimal viewing size when presented on a webpage. The resized panoramic image in then saved 52 to a web server 53. A portion of the panoramic image is cropped 54 and used as a thumbnail image on the webpage. The thumbnail image is resized to a predetermined height 56 to provide an optimal viewing size on the webpage. The resized, cropped thumbnail image is then saved 58 to a web server 53.

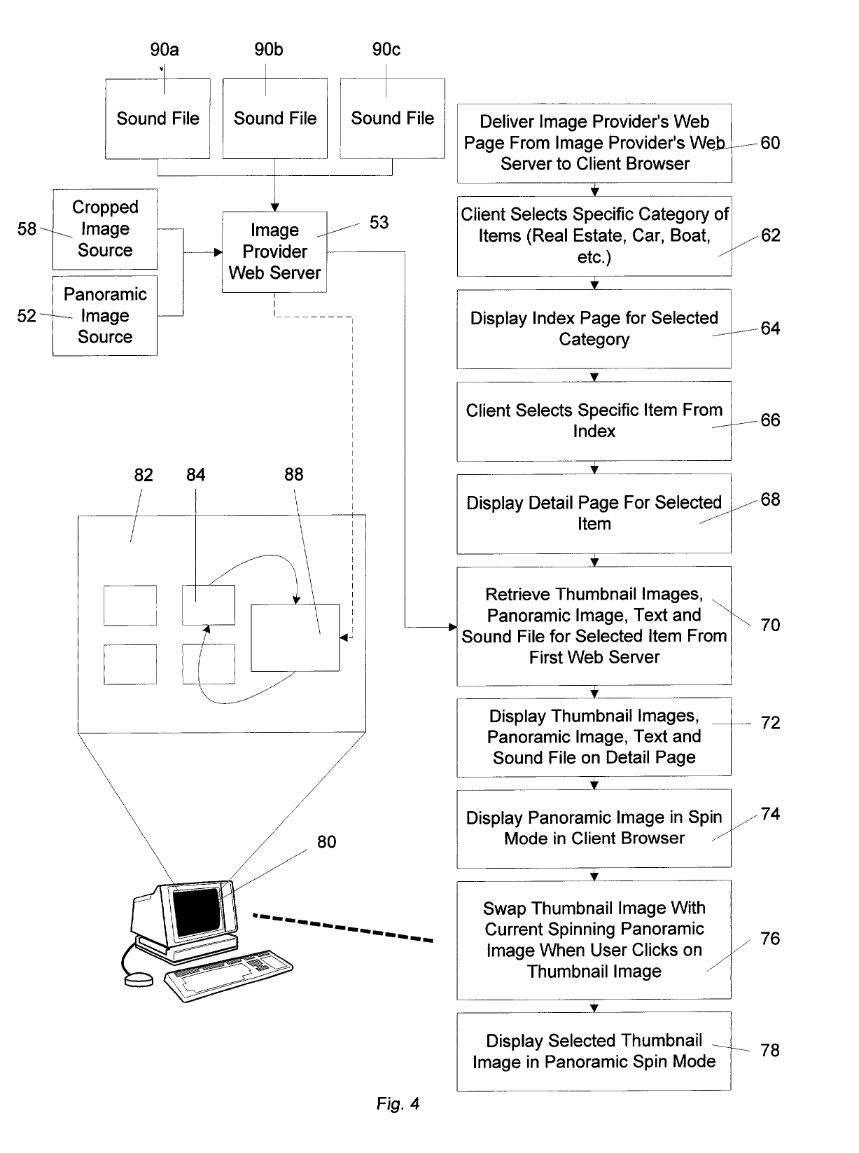

FIG. 4 illustrates the method of presenting the panoramic and thumbnail images and sound files on an Internet webpage. Initially, the homepage of the overall web site is delivered 60 to a client browser 80 from the web server. A list of categories are presented on the homepage, from which the user can select a specific category 62. An index page is displayed for the selected category 64 which lists all of the relevant items that pertain to the previously selected category including a thumbnail picture in a photographic index format. The client then selects an item from the index 66 by clicking on a specific link or thumbnail image 84. A detail page is then displayed 68 which presents information for the specified item. Information associated with the specified item, including thumbnail images 58, panoramic images 52, descriptive text, and sound files 90a, 90b, 90c are retrieved from the web server 70. The retrieved information is then displayed on one, singular detail webpage 82. The panoramic image retrieved from the web server is then displayed in a ‘spin mode’ in the client browser 74. In the ‘spin mode’ the panoramic image rotates such that a 360° view is presented. When the user clicks on a thumbnail image 76, also displayed on the webpage 82, the thumbnail image 84 swaps screen positions with the currently spinning panoramic image 88. Thus, the panoramic image 88 now is displayed as a still, thumbnail image at the location where the previous thumbnail image was located, and the thumbnail image 84 is now displayed in the area where the original panoramic image 88 was displayed. Further, after the thumbnail image is displayed in the panoramic area of the screen, it begins to ‘spin,’ thereby giving the perception of a 360° view.

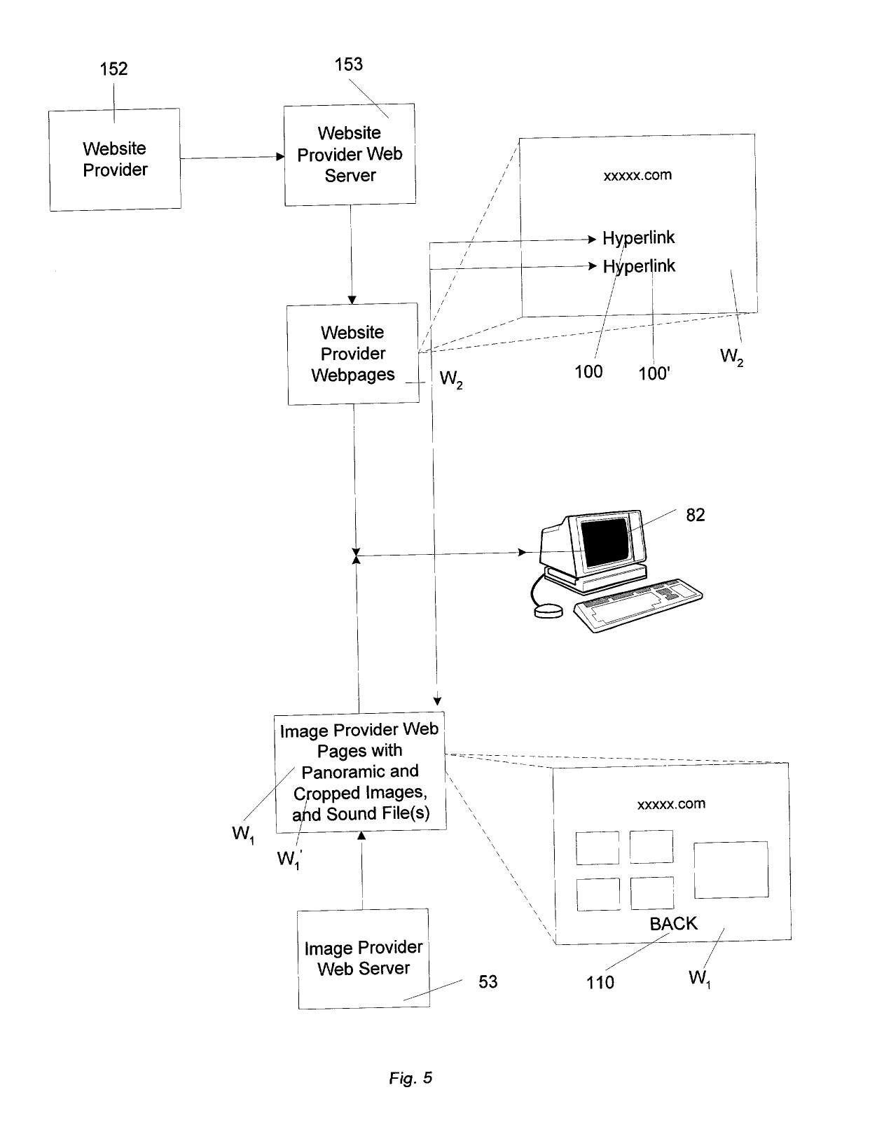

FIG. 5 illustrates the steps of interchanging the web page provided from the Website Provider's web server which is displayed on the user's screen with an entire webpage provided from the Image Provider's web server. The Website Provider 152 supplies web pages to the user's screen 82 which are stored on the Website Provider web server 153. The Website provider webpage W₂ contains descriptive text relating to the specific webpage and various hyperlinks 100 and 100′. Upon actuation of one of the hyperlinks 100 or 100′, the Image Provider web server 53 provides a webpage W₁ which may includes text, cropped images, panoramic images, and sound files to the user's screen 82, thereby replacing the previously displayed webpage W₂. The Image Provider web page W₁ contains a hyperlink 110 which allows the user to see the most recently displayed web page.

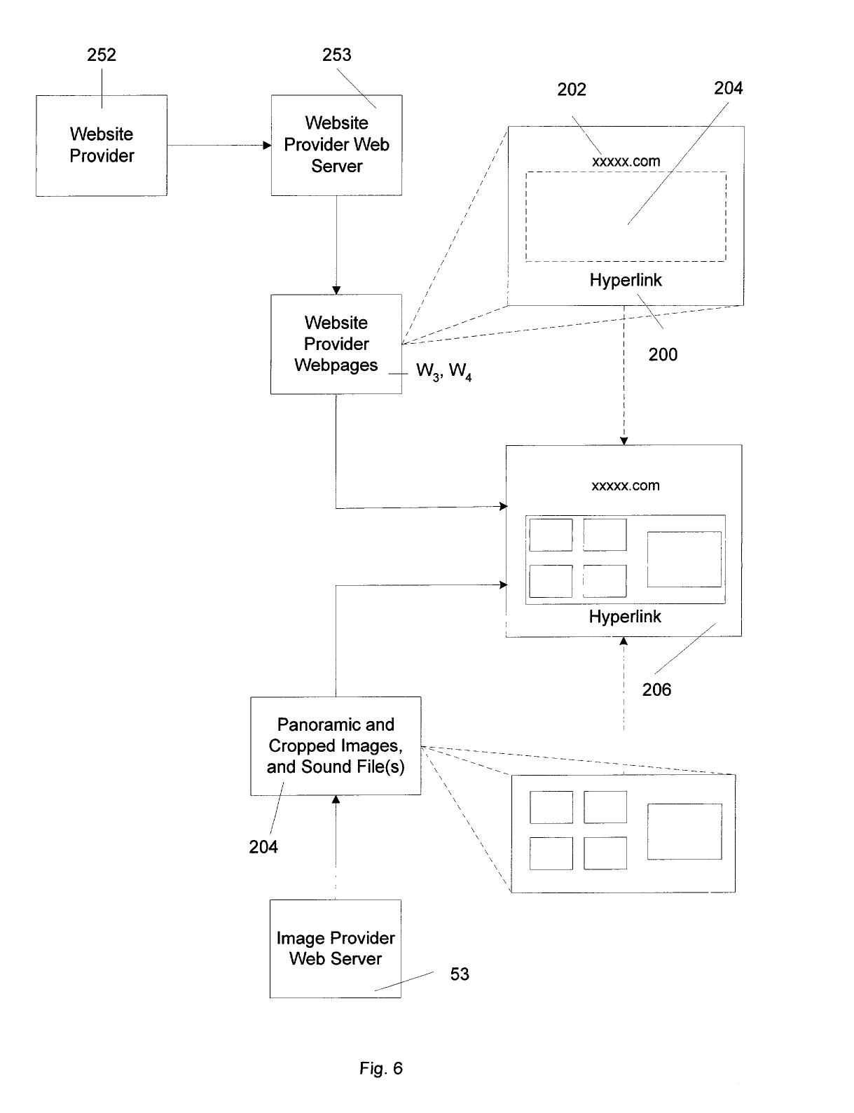

FIG. 6 illustrates the steps of presenting the panoramic and cropped images, and sound files from the Image Provider server to a webpage supplied from a separate web server, the Website Provider web server. The Website Provider 252 saves various information, including webpages, to the Website Provider web server 253. Webpages such as W3 and W4 include text 202, hyperlinks 200, and defined areas 204 into which images may be placed. The Image Provider web server 53 supplies panoramic and cropped images, and sound files 204 to the web pages W3 and W4 which are then jointly displayed within one webpage 206.

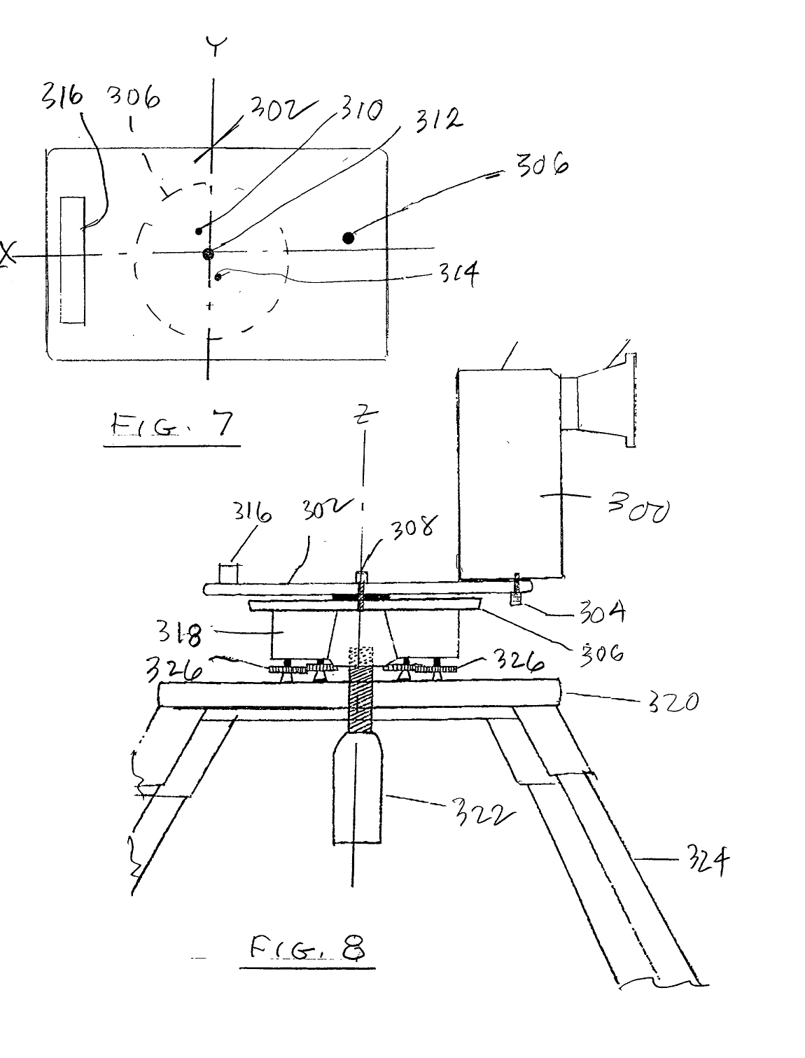

Referring now to FIGS. 7 and 8, the camera 300 for taking the panoramic pictures is a digital camera that is fastened to one end of the mounting plate 302 by a thumbscrew 304 that extends through the mounting opening 306. The mounting plate 302 is removably fastened to the rotatable turntable 306 by three thumbscrews 308 that extend through corresponding openings 310,312, 314 contained in the center portion of the mounting plate 302. A level 316 is mounted on the opposite end of the mounting plate in generally equally spaced relation from the central mounting opening 312 as the camera 300. The turntable base 318 is connected for angular adjustment with the tripod body 320 by the main mounting screw 322, which tripod body is supported by three tripod legs 324, as is known in the art.

Four orthogonally arranged adjusting screws 326 are provided for adjusting the orientation of the turntable base 318 relative to the tripod body about horizontal X and Y axes, thereby to insure that the mounting plate 302 is accurately leveled as determined by level 316 for various rotational positions of plate 302 and camera 300.

In operation, after the tripod has been located at a desired position (such as at a central location in a room to be displayed, for example), the thumb screws 326 are adjusted for various rotational positions of the plate 302 about central axis 312, whereby the mounting plate 302 is accurately leveled. The photographer progressively rotates the plate 302 through 360° while simultaneously taking a number of photographs of the panoramic view being photographed.

Preferably, the plate 302 is formed of ¼ inch aluminum, and is about 3 5/16 by 6½ inches in size.

Once a panoramic tour of the room has been photographed, it is brought into the office on 5-6 diskettes. Every picture is then opened in Microsoft Photo Editor and checked for clarity. The photographer checks for parts of the photo that have been washed out because of the sun or darkened because of a shadow. Each picture is individually enhanced for the most consistent quality so no visible seams appear in the final product.

Once the pictures have been individually reviewed in Photo Editor, they are imported into PhotoVista, a Live Pictures, Inc., product. PhotoVista, a patented “stitching” software, takes the individual frames produced by the photographer and “sews” them together into one long panoramic image. Each frame overlaps the previous frame. If the pictures were taken exactly level, then the stitching program has a relatively easy time matching the frames. If the original pictures wee not taken on a perfectly level plane, then the picture begins to skew or run uphill or downhill. The photographer then crops or cuts off all of the images from every frame that are higher than the skewed image. This may result in having a roof cropped off of a house, even though the initial frame which included the house originally held the entire image. The alternative is to publish an image with a “hole” in it. Neither scenario is acceptable.

This is the most critical stage because the quality of the photos will only deteriorate when transmitted over the web. An imperfect flat panoramic will only become poorer when imported into the spin program. It will never improve.

Once an acceptable stitched panoramic has been produced, it is saved. Since there are no precision sizing tools in PhotoVista, the image is reopened in Photo Editor and resized to a specified height that our viewer is set to accommodate. A “thumbnail” to be used on the Index page and the Detail page is cropped out as a representative still photo of what the tour contains.

The tours and the thumbnails are sized to an exact predetermined pixel count. They must be large enough to show the detail, but small enough that the download speed does not discourage viewers. through trial and error, it has been determined that a tour 300-pixels high gives both the quality and the speed that is needed. The thumbnails are all 150 pixels wide and 100 pixels tall (This also gives a relationship of 50 percent on a four and one detail layout.).

Once the tours have been stitched and the thumbnails saved, it is time to add it to the Website.

According to the present invention, the home is viewed as sold. Rather than putting the buyers through a series of search requirements, the site is picture driven, and can be modified to suit special client needs, where the client does not have to enter his own information (he does not even have to have a Website), and clients can link to the image provider. For example, beginning on the Home Page, the top navigation bar may show that there are six sections to the site—Home Page, Classified's, Real Estate, Help Wanted/Jobs Wanted, Our Delmarva, and Contact Us.

Once a person comes to the image provider's site, he can get to the real estate section in one of two ways. If it is their first time on the site, they will probably click on the Real Estate (RE) button on the navigation bar. This takes them to the RE home page which explains what a virtual tour is, how to list their property, and how to navigate the site. In addition, that homepage has a list on the left of every real estate category on the site. To proceed to look at houses, they choose a category of real estate—some categories are based on type of home, others are by location, and still others are based on commercial vs. residential. To view a listing of homes, the viewer must choose a category from the list at the left. At that point, they are taken to a RE Index page.

If a person has been on the site before, he can go to the dropdown box on the Home Page where it says Categories and choose the category he would like to view. As soon as the selection is made, he is taken directly to the Index page of the selected category.

The Index Page is again designed to be simplistic. It is alphabetized by the “Title” field which is used to hold the address of the property. A short one line “teaser” headline is shown, the price, and a thumbnail of the property. The advantage is that you see ALL of the properties in a category, not just the ones the computer thinks are an appropriate match to your query. If you want to search across numerous categories, the Search function will create a custom Index based on your request. Again, all picture indexed.

Once you select a property you wish to have details on, you simply click on the thumbnail, and it will launch the detail page. This page is the most significant of the Website.

The Real Estate Detail Page is the most significant page on the site. When you view a detail page, you see a page that has four small photos to the left and one large moving tour on the right. Under each of the small photos on the left is a potential tour. Click on the small photo, and it will “jump” to the large viewer on the right. If it is a tour, it will automatically start rotating, otherwise, it will just project a large still image to the viewer (which doesn't have to be the same picture as the small photo).

The description of the listing remains on the same page as the tours at all times. You never have to leave the description of a property to tour the home or go to someone else's Website to retrieve the pictures. They are always an integral part of the listing, and your name stays in front of the potential buyer at all times.

All other virtual tours of the prior art require you to leave the real estate site and retrieve the tour from another “picture” site. According to the present invention, the technologies are confined onto a single page whereby the viewer never leaves the real estate listing to preview a tour.

While in accordance with the provisions of the Patent Statutes the preferred form and embodiment of the invention have been illustrated and described, it will be apparent to those skilled in the art that various changes may be made without deviating from the inventive concepts set forth above.

What is claimed is:

1. A method for presenting on an Internet Website by an image provider selected images of a plurality of panoramic views, comprising:
(a) photographing each of a plurality of panoramic views by taking a plurality of successive digital photographs in a given plane through a 360° field of vision;
(b) stitching the photographs of each view to form a corresponding digital panoramic image, respectively;
(c) cropping each of said panoramic images to produce a desired given section of said panoramic image, respectively;
(d) storing on an image provider web server for each of said panoramic views both the panoramic image and its cropped section, respectively;
(e) displaying in a spinning mode at a first location (88) on the monitor screen (82) of a client user the panoramic image of a first one of said views;
(f) displaying in a stationary mode at a second location (84) on said screen the cropped section associated with a second panoramic image; and
(g) actuating the cropped section of the second panoramic image at said second location (84), thereby to simultaneously:
(1) swap at said first location (88) the panoramic image of said second view in a spinning mode; and
(2) swap at said second location (84) in a stationary mode the associated cropped image of the first panoramic image.

2. A method for presenting selected images on an Internet Website as defined in claim 1, and further including:
(h) recording on said image provider web server (53) a sound file (90a) corresponding with a given panoramic view; and
(i) retrieving from said image provider web server (53) said sound file when the image of said given view is displayed at said first location (88).

3. A method for presenting selected images on an Internet Website as defined in claim 1, and further including:
(h) recording on said image provider web server (53) a plurality of sound files (90a, 90b, 90c) corresponding with a plurality of panoramic views, respectively; and,
(i) retrieving from said image provider web server (53) that sound file that corresponds with that view the image of which is being displayed at said first location (88).

4. A method for presenting selected images on an Internet Website as defined in claim 1, and further including:
(h) initially storing on a Website provider web server (153) a Website provider web page (W₂);
(i) initially displaying said Website provider web page on said monitor screen (82);
(j) storing on said image provider web server (53) an image provider web page (W₁); and
(k) actuating a hyperlink (100) on said displayed second web page (W₂) to operate said image provider server (53), thereby to substitute on said monitor screen said image provider web page (W₁) for said Website provider web page (W₂).

5. A method for presenting selected images on an Internet Website as defined in claim 4, and further comprising:
(k) storing a plurality of said first web pages (W₁, W₁′) on said image provider web server (53);
(l) providing a plurality of hyper links (100, 100′) on said second web page (W₂) corresponding with said first web pages, respectively; and
(m) actuating one of said hyperlinks to display on said monitor screen the web page from Image Provider Web Server (53) associated with said hyperlink.

6. A method for presenting selected images in an Internet Website as defined in claim 5, wherein said first web page (W₁) and said second web page (W₂) have the same visual appearance.

7. A method for presenting selected images on an Internet Website as defined in claim 1, and further including:
(h) initially storing on a Website provider web server (253) a plurality of Website provider web pages (W₃, W₄);
(i) initially displaying one of said Website provider web pages (W₃) on said monitor screen (82);
(j) actuating a hyperlink (200) on said one Website provider web page (W₃) to:
(1) swap on said monitor screen for said one Website provider web page (W₃) a second one of said Website provider web pages (W₄); and
(2) displaying within said second Website provider web page (W₄) said panoramic and cropped images (204) from said image provider web server (53).

8. Apparatus for presenting on an Internet Website by an image provider selected images of a plurality of panoramic views, comprising:
(a) a digital camera (300); and
(b) means supporting said camera for rotation in a horizontal plane through 360° about a given vertical axis, including:
(1) a stationary tripod including a tripod body (320);
(2) a plurality of legs (324) supporting said tripod body relative to a generally horizontal support;
(3) a turntable base (318);
(4) a plurality of leveling screws (326) supporting said turntable base on said tripod body for adjustment about a pair of horizontal orthogonally arranged axes (X, Y);
(5) a turntable (306) connected with said turntable for rotation about a vertical axis (Z) normal to said pair of axes;
(6) a horizontal mounting plate (302) having a center portion connected with the upper surface of said turntable, said camera being mounted at one end of said mounting plate in spaced relation to said vertical axis; and
(7) a level (316) mounted on the opposite end of said mounting plate, said level and said camera being spaced generally an equal distance from said vertical axis.

9. Apparatus for presenting an Internet Website as defined in claim 1, and further including means (322) adjustably connecting said turntable base with said tripod body.
